(19) United States
(12) Patent Application Publication
(10) Pub. No.: US 2014/0356081 A1
(43) Pub. Date: Dec. 4, 2014

(54) END MILL WITH HIGH RAMP ANGLE CAPABILITY

(71) Applicant: Kennametal Inc., Latrobe, PA (US)

(72) Inventor: Danny Ray Davis, Asheboro, NC (US)

(73) Assignee: Kennametal Inc., Latrobe, PA (US)

(21) Appl. No.: 13/905,357

(22) Filed: May 30, 2013

(51) Int. Cl. B23C 5/10; B23C 5/28

(52) U.S. Cl. CPC B23C 5/10; B23C 5/28; B23C 2210/045; B23C 2210/0457; B23C 2210/0485; B23C 2210/40; B23C 2250/12
USPC 407/11; 407/54

(57) ABSTRACT

A rotary cutting tool with a longitudinal axis includes a shank portion, a cutting portion, and a cutting tip. The cutting portion includes a plurality of blades and a plurality of flutes. Each blade includes a leading face, a trailing face, and a land surface extending between the leading face and the trailing face. The cutting tip includes a corner radius, a first portion formed with a first dish angle, and second portion formed with a second dish angle and a third portion formed with a third dish angle. The trailing face contacts the work during a ramp operation in such a way that the first, second and third portions have a double positive geometry to provide the cutting tool with high ramp angle capability.

### FIELD OF THE INVENTION

The invention pertains to a rotary cutting tool. More particularly, the invention relates to a solid end mill having a double positive end geometry (i.e., positive axial and radial rakes on both the leading and trailing edges) that enables the end mill to perform a ramp operation at an extremely high ramp angle.

### BACKGROUND OF THE INVENTION

At its most basic, milling is the meeting of a rotating tool with a clamped and stationary workpiece, as opposed to turning where the tool is stationary and the work material rotates. Actually, the workpiece has feed motion imparted from the machine tool. The meeting of the rotary motion of the cutter and the cutting edge of the tools produces fluctuating cutting forces: vibration, heat, and, if all goes well, chips.

Milling machines may have either vertical or horizontal spindle orientation, and typically, face milling cuts flat surfaces, but multi-axis CNC machines make it possible to include three-dimensional movements. That said, there are four basic categories of milling: face milling, periphery milling, slot milling, and specialty applications.

Face milling is used for creating a flat surface (face) on the workpiece. The cutting plane is usually perpendicular to the axis of rotation and the cutters most often feature a single row of inserts, designed with a wide range of cutting geometries, inserts, lead angles, and mounting adaptations. Surface finish requirements are an important input to determine the best tool type. Typically, face milling is performed by tools offering a lead angle for long tool life and reduced chance of breakout when exiting the workpiece.

Periphery milling generates a primary surface parallel to the spindle rotation. A secondary surface is sometimes produced. The cutting plane is usually parallel to the axis of rotation. Periphery milling cutters can be high-speed steel, solid carbide, or indexable-insert-based. Insert-based cutters may include one or more rows of inserts and may produce a simultaneous face-milling operation.

Slot milling is used for producing a slot or channel in the workpiece. There are two primary types of slot milling cutters: disk mills and end mills. Disk mills can be high-speed steel, brazed carbide, and indexable-insert-based. They are typically used in operations perpendicular to the spindle rotation.

End mills used for slot-milling operations are similar to the tools used in periphery milling. The slot being generated is parallel to the spindle rotation. However, because of full engagement in the periphery, poor chip formation, and evacuation, end mills are not a first choice for slotting operations.

While very versatile, end mills are the least stable of all milling cutters due to the smaller tool diameter and greater length. The diameter is the weakest portion of the tool because of the high tangential forces directed across it.

Specialty applications include Z-axis plunge milling, ramping, helical and circular interpolation, trochoidal, and others.

Z-axis plunge milling is commonly used for removing large amounts of workpiece material. Cutting forces are directed into the cutter axially for higher metal-removal rates with long reach capability. The cutting plane is perpendicular to the axis of rotation.

Ramping creates an angled surface on the workpiece or is used at the point of entry for making a pocket (pocketing). Compared to plunging, ramp milling may be less productive depending on conditions. This is also a common application requirement for pocket milling from a solid workpiece.

Helical and circular interpolation is commonly used for creating a cylindrical surface on the workpiece, or for creating entry points for later applications. This application does not necessarily require an existing hole, depending on the type of tool chosen.

Trochoidal milling is an application that typically produces a slot in difficult-to-machine materials. It uses a combination of periphery milling and circular interpolation in the X and Y planes.

In milling, ramping has gradually grown more significant. The speed and precise interpolation of modern CNC machines make it possible for a small tool to mill out a much larger hole or pocket in a relatively short time. Ramping is an important element of doing this. Either the tool ramps from one level of passes to the next within the feature, or else it follows a helical path at a continuous angle all the way down to the feature's depth.

Limitations on the ability to ramp generally result from the tool.

Many end mills that are able to ramp were not necessarily designed to emphasize this type of cutting. When the tool is designed with ramping in mind, various features change.

A tool that has the capability to ramp at a steeper angle reaches the bottom of the feature sooner, potentially reducing machining time. Thus, it would be desirable to design an end mill that is capable of an extremely high ramp angle (i.e., greater than ten (10) degrees) during ramping.

### SUMMARY OF THE INVENTION

The problem of designing an end mill that is capable of an extremely high ramp angle (i.e., at least ten (10) degrees) is solved by providing an end mill having a cutting tip with a double positive geometry (i.e., both positive axial and radial rakes on both the leading and trailing edges) when the trailing face contacts the work during a ramp operation without contacting the work at the center of the end mill.

In one aspect of the invention, a rotary cutting tool with a longitudinal axis comprises a shank portion; a cutting portion extending from the shank portion to a cutting tip, the cutting portion having a length of cut, and a plurality of blades separated by flutes extending along the length of cut, each of the blades including a leading face, a trailing face, a land surface extending between the leading face and the trailing face, and a cutting edge at the intersection between the leading face and the land surface, the cutting tip comprising a corner radius, a first portion proximate an outer diameter of the rotary cutting tool, a third portion proximate the central axis, and a second portion between the first and third portions, wherein the trailing face contacts a work during a ramp operation in such a way that the first, second and third portions of the cutting tip have a double positive geometry, thereby enabling the rotary cutting tool to perform the ramp operation with a ramp angle of at least ten degrees.

In another aspect of the invention, a rotary cutting tool with a longitudinal axis comprises a shank portion; a cutting portion extending from the shank portion to a cutting tip, the cutting portion having a length of cut, and a plurality of blades separated by flutes extending along the length of cut, each of the blades including a leading face, a trailing face, a land surface extending between the leading face and the trailing face, and a cutting edge at the intersection between the leading face and the land surface, the cutting tip comprising a corner radius, a first portion proximate an outer diameter of the rotary cutting tool and formed with a first dish angle with respect to a plane perpendicular to the central axis, a third portion proximate the central axis and formed with a third dish angle with respect to the plane perpendicular to the central axis, and a second portion between the first and third portions and formed with a second dish angle with respect to the plane perpendicular to the central axis, wherein the first dish angle is smaller in magnitude than the second dish angle, and wherein the second dish angle is smaller in magnitude than the third dish angle, and wherein the trailing face contacts a work during a ramp operation in such a way that the first, second and third portions of the cutting tip have a double positive geometry, thereby enabling the rotary cutting tool to perform the ramp operation with a ramp angle of at least ten degrees.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a perspective view of a rotary cutting tool with high ramp angle capability in accordance with an embodiment of the invention;

FIG. 2 is an enlarged perspective view of the cutting portion of the rotary cutting tool of FIG. 1;

FIG. 3 is a cross-sectional view of the rotary cutting tool taken along line 3-3 of FIG. 2;

FIG. 4 is an enlarged side view of the rotary cutting tool of FIG. 1 showing the cutting tip with multiple dish angles;

FIG. 5 is another enlarged side view of the rotary cutting tool of FIG. 1 showing the positive axial rake angle of the cutting tip;

FIG. 6 is an end view of the rotary cutting tool of FIG. 1 showing the positive end rake angle of the cutting tip; and

FIG. 7 is a schematic view of the rotary cutting tool of FIG. 1 during a ramp operation showing the trailing face of the blade contacting the work, thereby enabling the rotary cutting tool to have a high ramp angle capability of at least ten degrees.

### DETAILED DESCRIPTION OF THE INVENTION

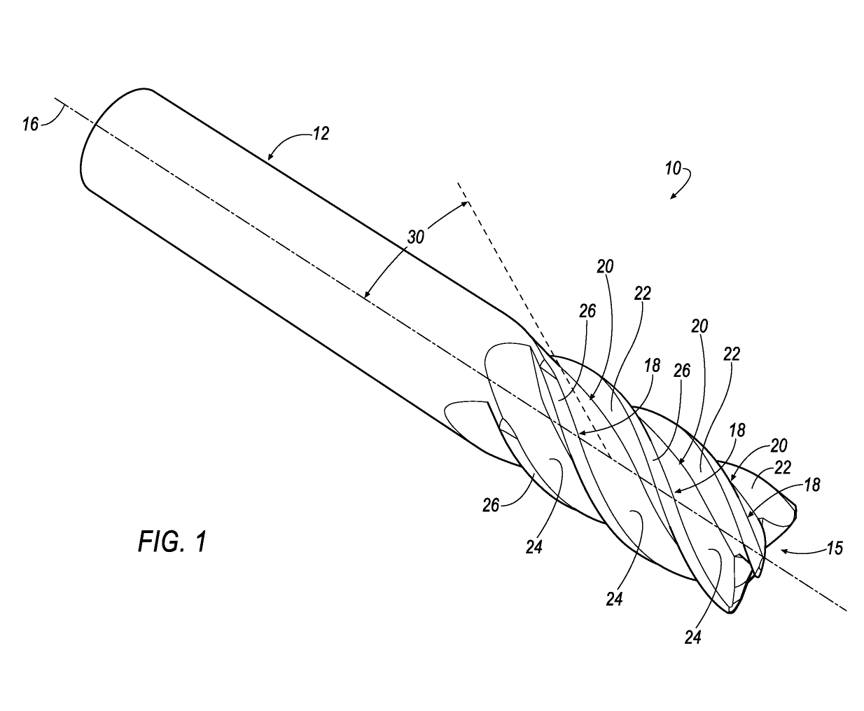

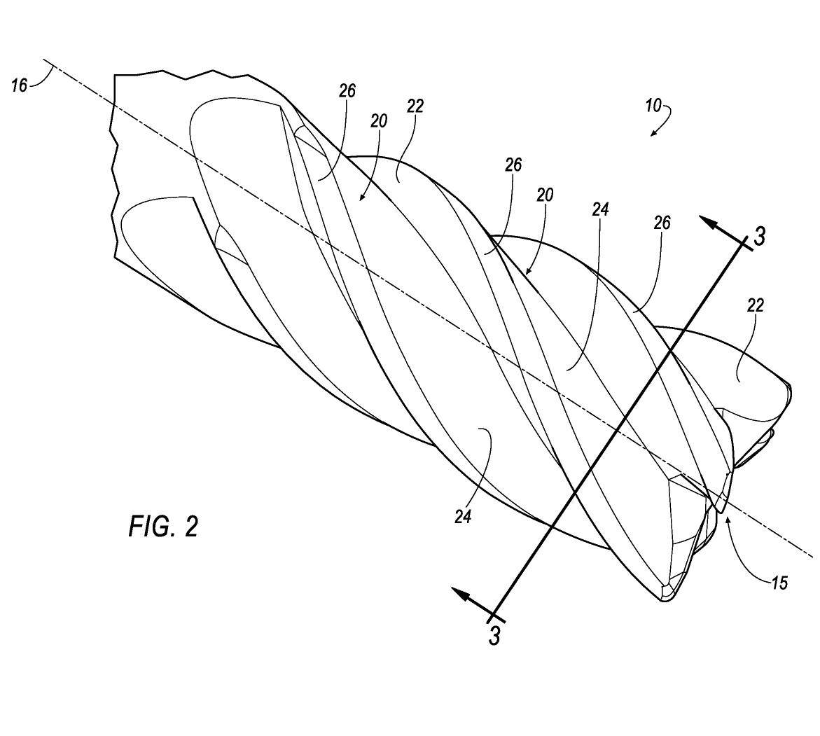

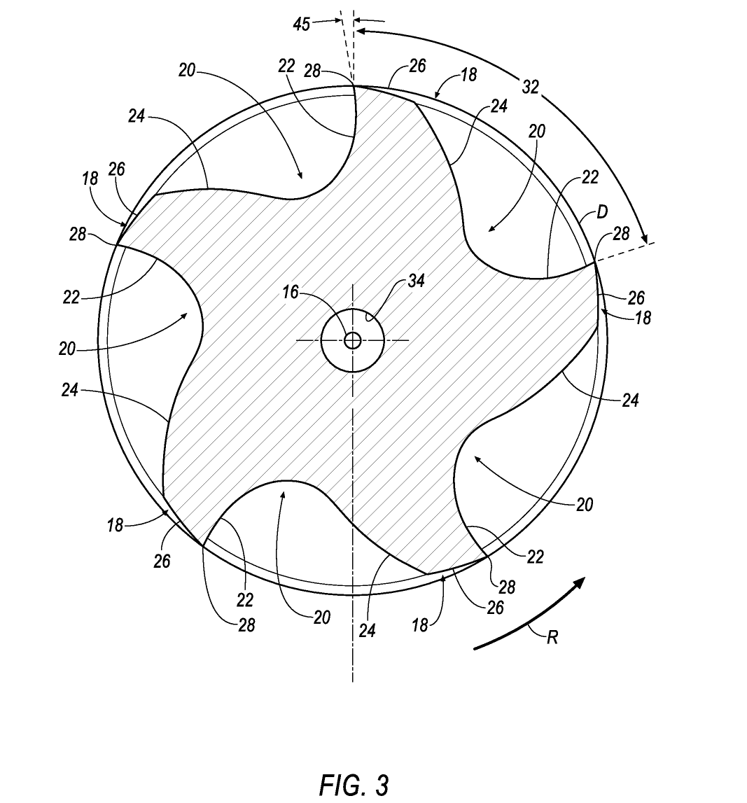

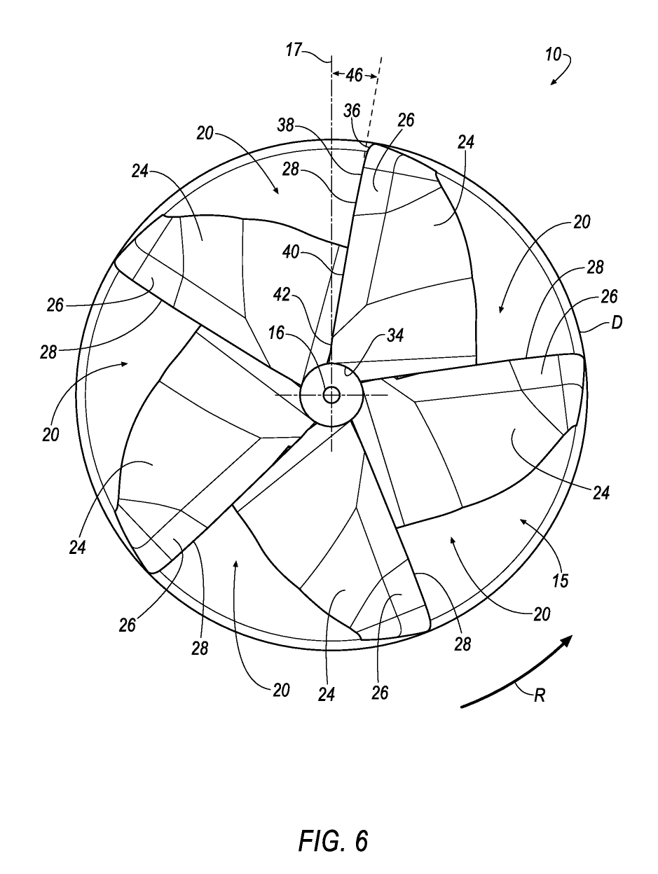

Referring now to FIGS. 1-3, a rotary cutting tool 10 is provided that includes a shank portion 12, a cutting portion 14 having a cutting tip 15, and a longitudinal axis 16. In the illustrated embodiment, the rotary cutting tool 10 comprises a solid end mill having a cutting diameter, D (FIGS. 3 and 6). The overall shape of the cutting portion 14 may be, but is not limited to, a cylindrical shape or a frusto-conical shape. The cutting portion 14 includes a plurality of blades 18 separated by flutes 20 extending the length of the cutting portion 14. The end mill 10 rotates in a direction of the arrow, R (FIGS. 3 and 6). Each of the blades 18 has a leading face 22, a trailing face 24, and a land surface 26 bridging the leading face 22 and trailing face 24. The intersection between the leading face 22 and the land surface 26 forms a cutting edge 28 for the respective blade 18.

As used herein, axial rake angle is defined as the angle between the cutter tooth face of a blade of a milling cutter or reamer and a line parallel to its axis of rotation. Radial rake angle is defined as the angle between the cutter tooth face of a blade and a radial line passing through the cutting edge in a plane perpendicular to the cutter axis. End rake angle is defined as the angle between the cutting tip at the end of a blade and a radial line passing through the cutting edge in a plane perpendicular to the cutter axis. Positive axial rake angle is defined as a rake geometry indicating that the that the cutting edge is positioned on the axial centerline of the cutter with the top surface of the cutting edge sloping back and away from the axial centerline. Positive radial rake angle is defined as a rake geometry indicating that the cutting edge is positioned on the radial centerline of the cutter with the top surface of the cutting edge sloping back and away from the radial centerline. Positive end rake angle is defined as a rake geometry indicating that the cutting tip at the end of the blade is positioned on the radial centerline of the cutter with the cutting tip sloping back and away from the radial centerline. A double positive geometry is defined as a tool orientation that uses a combination of positive axial and radial rake angles or a combination of positive axial and end rake angles. Ramp milling is defined as a combination of Z-axis movement simultaneous with X, Y, or combined axis movement. Dish angle is defined as the angle formed by the end cutting edge with respect to a plane perpendicular to the cutter axis. Helix angle is defined as the angle made by the leading face of the land with a plane containing the cutter axis. Ramp angle is defined as the angle made by the cutter when moving the cutter in both the Z-axis direction and an additional axis (X- or Y-axis) relative to the work, and is defined by the equation:

Ramp Angle=Tan/1×Z-axis feed / X/Y-axis feed (1).

High ramp angle is defined as a ramp angle of at least ten (10) degrees.

In the illustrated embodiment, the end mill 10 has a total of five (5) blades 18 and flutes 20. However, it will be appreciated that the invention is not limited by the number of blades and flutes, and that the invention can be practiced with a fewer or a greater number of blades and flutes. For example, the invention can be practiced with four (4) blades and flutes, six (6) blades and flutes, eight (8) blades and flutes, and the like.

The blades 18 and flutes 20 of the cutting portion 14 extend helically within the cutting portion 14 at a helix angle 30 of between about thirty (30) and about forty-five (45) degrees with respect to the longitudinal axis 16. In other embodiments, the blades 18 and flutes 20 are “straight flutes” that extend parallel to the longitudinal axis 16. In the illustrated embodiment, the blades 18 and flutes 20 of the cutting portion 14 extend helically within the cutting portion 14 at a helix angle 30 of about thirty-eight (38) degrees.

Referring now to FIG. 3, the angular spacing 32 between the blades 18 and flutes 20 is substantially equal. In the illustrated embodiment, for example, the angular spacing is about seventy-two (72) degrees (360 degrees/5 blades=72 degrees). However, it will be appreciated that the invention is not limited by equally spaced blades and flutes, and that the invention can be practiced with unequally spaced blades and flutes. Further, the cutting edge 28 of each blade 18 forms a positive radial rake angle 45. In addition, the end mill 10 includes a coolant hole 34 for providing coolant to the interface between the end mill 10 and the work. In the illustrated embodiment, the coolant hole 34 is concentric with the central axis 16 of the end mill 10. It should be appreciated that the coolant hole 34 is optional and the invention can be practiced without a cooling hole if desired.

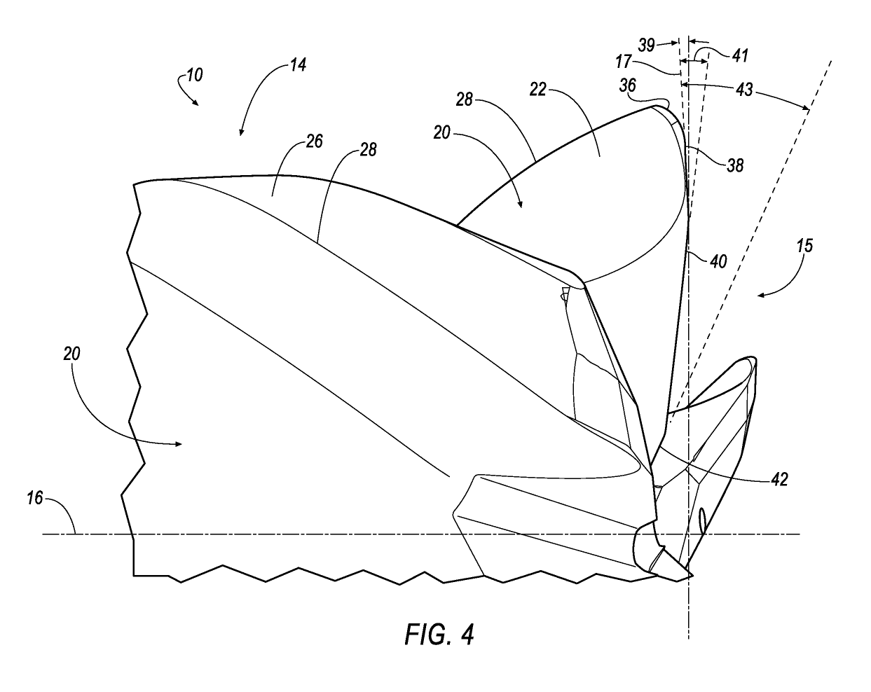

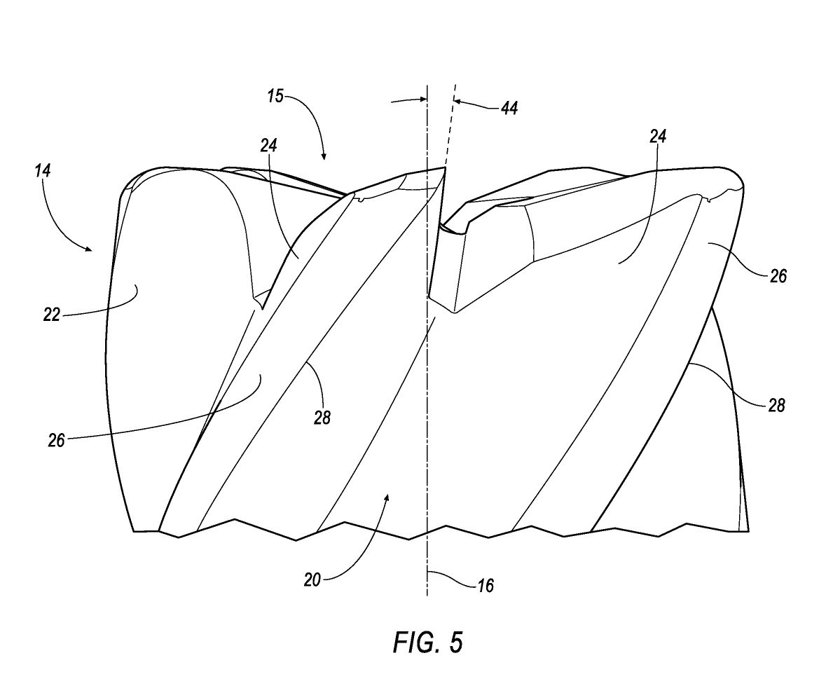

Referring now to FIGS. 4 and 5, one aspect of the invention is that the end profile of the cutting tip 15 of the end mill 10 is such that the cutting tip 15 of each blade 18 has multiple dish angles and a double positive geometry (i.e., both positive axial and radial rake angles) when both the leading face 22 and the trailing face 24 contact the work 100. As a result, the end mill 10 of the invention has the capability to achieve high ramp angles greater than ten (10) degrees. It is well-known that the inner diameter (I.D.) is the radially innermost portion of the cutting tip 15 proximate the coolant hole 34, and the outer diameter (O.D.) is the radially outermost portion of the cutting tip 15 proximate the periphery of the end mill 10.

As shown in FIG. 4, the cutting tip 15 of each blade 18 includes a corner radius 36 for providing strength to the cutting corner, a first cutting portion 38 having a first dish angle 39 with respect to a plane 17 perpendicular to the central axis 16, a second, intermediate cutting portion 40 having a second dish angle 41 and a third cutting portion 42 having a third dish angle 43. More specifically, the first dish angle 39 is smaller in magnitude than the second and third dish angles 41, 43, and the second dish angle 41 is smaller in magnitude than the third dish angle 43. In other words, the third dish angle 43 is larger in magnitude than both the first and second dish angles 39, 41. For example, the first dish angle 39 can be in a range between about one (1) degree to about eight (8) degrees, the second dish angle 41 can be in a range between about nine (9) degrees to about twenty (20) degrees, and the third dish angle 43 can be in a range between about twenty-one (21) degrees to about forty-five (45) degrees. In one embodiment, the first dish angle 39 is about four (4) degrees, the second dish angle 41 is about thirteen (13) degrees and the third dish angle 43 is about thirty-eight (38) degrees. It will be appreciated that the invention can be practiced with other dish angles, so long as the first dish angle 39 is smaller in magnitude than the second and third dish angles 41, 43, and that the third dish angle 43 is larger in magnitude than both the first and second dish angles 39, 41.

Referring now to FIGS. 3-6, another aspect of the invention is that the leading face 22 and the trailing face of the end mill 10 has a double positive geometry. More specifically, both the first cutting portion 38 proximate the outer diameter and the third cutting portion 42 proximate the inner diameter of the leading face 22 of the end mill 10 have a double positive geometry (i.e., both a positive axial rake angle 44 and a positive radial rake angle 45). In addition, both the first cutting portion 38 proximate the outer diameter and the third cutting portion 42 proximate the inner diameter of the trailing face 22 of the end mill 10 have a double positive geometry (i.e., both a positive axial rake angle 44 and a positive end rake angle 46). The axial, radial and end rake angles 44, 45, 46 can be in a range between about one (1) degree and about fifteen (15) degrees. For example, in one embodiment, the axial, radial and end rake angles 44, 45, 46 are about seven (7) degrees.

The combination of the multiple dish angles and the double positive geometry of the first and third cutting portions 38, 42 at the cutting tip 15 enables the end mill 10 of the invention to aggressively cut the work all the way to the coolant hole, thereby providing an extremely high ramp angle capability as compared to conventional end mills. More specifically, the multiple dish angles and the double positive geometry of the cutting tip enables the end mill 10 of the invention to ramp at an extremely high ramp angle of at least ten (10) degrees in the direction of the arrow 48.

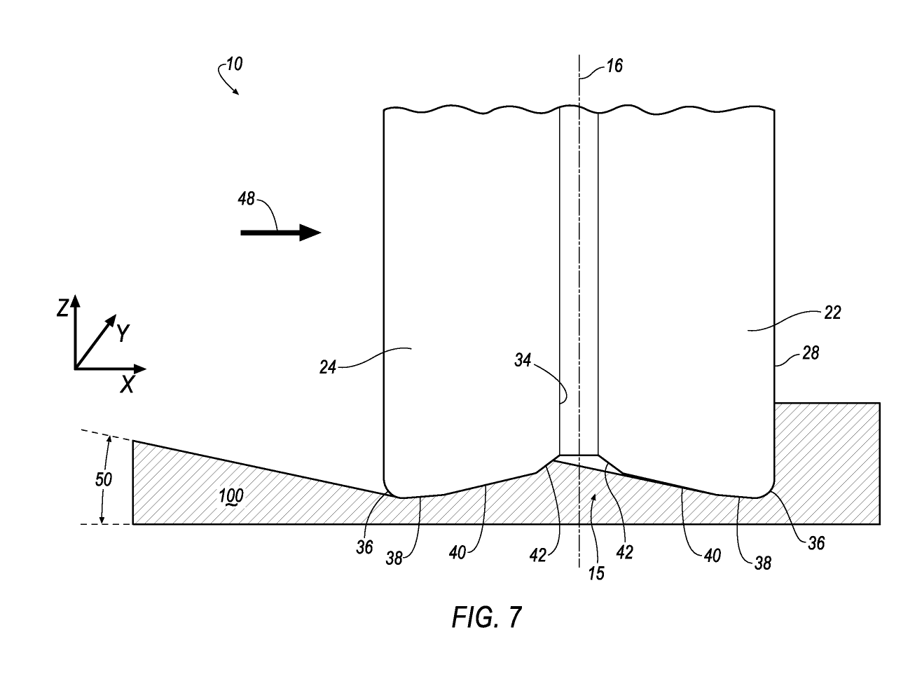

FIG. 7 shows a schematic diagram of the end mill 10 of the invention during a ramp operation (i.e., moving in the x-z plane) at a ramp angle 50 of greater than ten (10) degrees. In the illustrated embodiment, the ramp angle 50 is about twelve (12) degrees. As shown in FIG. 7, the end mill 10 rotates in the clockwise direction and the leading face 22 is the right-hand side of the end mill 10 shown in FIG. 7, while the trailing face 24 is the left-hand side of the end mill 10 shown in FIG. 7. During the ramp operation, only the corner radius 36 and the first cutting portion 38 of the cutting tip 15 contact the work 100 at the leading face 22. Although it may appear that the second portion 40 of the cutting tip 15 may be slightly contacting the work 100 in FIG. 7, in reality, the second cutting portion 40 and the third cutting portion 42 of the cutting tip 15 do not contact the work 100. When the leading face 22 contacts the work 100, the corner radius 36 of the cutting tip 15 has both a positive axial rake angle 44 and a positive radial rake angle 45 (i.e., a double positive geometry), while the first cutting portion 38 of the cutting tip 15 has a positive axial rake angle 44, but a negative end rake angle 46.

On the other hand, all three cutting portions 38, 40, 42 at the cutting tip 15 when the trailing face 24 contacts the work 100. That is, the first cutting portion 38, the second cutting portion 40 and the third cutting portion 42 of the cutting tip 15 contact the work 100 at the trailing face 24. The corner radius 36 may contact the work 100, but not the entire corner radius 36, unlike the entire corner radius 36 when the leading face 22 contacts the work 100. When the trailing edge 24 contacts the work 100, all three cutting portions 38, 40, 42 of the cutting tip 15 have both a positive axial rake angle 44 and a positive end rake angle 46 (i.e. a double positive geometry), thereby providing an end mill with high ramp angle capability.

As described above, the trailing face 24 of the end mill 10 contacts a work 100 during a ramp operation in such a way that the first, second and third portions 38, 40, 42 of the cutting tip 15 have a double positive geometry, thereby enabling the rotary cutting tool 10 to perform the ramp operation with a ramp angle 50 of at least ten degrees. As a result, the entire trailing face 24 of the end mill 10 aggressively cuts the work 100. In addition, the end mill 10 of the invention, which is a non-center cutting tool, is able to perform a plunge operation at an extremely high ramp angle, unlike conventional non-center cutting tools.

The patents and publications referred to herein are hereby incorporated by reference.

Having described presently preferred embodiments the invention may be otherwise embodied within the scope of the appended claims.

What is claimed is:

1. A rotary cutting tool with a central axis, comprising:
a shank portion;
a cutting portion extending from the shank portion to a cutting tip, the cutting portion having a plurality of blades separated by flutes, each of the blades including a leading face, a trailing face, a land surface extending between the leading face and the trailing face, and a cutting edge at an intersection between the leading face and the land surface, the cutting tip comprising a corner radius, a first portion proximate an outer diameter of the rotary cutting tool, a third portion proximate the central axis, and a second portion between the first and third portions,
wherein the trailing face contacts a work during a ramp operation in such a way that the first, second and third portions of the cutting tip have a double positive geometry, thereby enabling the rotary cutting tool to perform the ramp operation with a ramp angle of at least ten degrees.

2. The rotary cutting tool according to claim 1, wherein first portion is formed with a first dish angle with respect to a plane perpendicular to the central axis, the second portion is formed with a second dish angle with respect to the plane perpendicular to the central axis, and the third portion is formed with a third dish angle with respect to the plane perpendicular to the central axis.

3. The rotary cutting tool according to claim 2, wherein the first dish angle is smaller in magnitude than the second dish angle, and wherein the second dish angle is smaller in magnitude than the third dish angle.

4. The rotary cutting tool according to claim 1, wherein the rotary cutting tool comprises a solid end mill.

5. The rotary cutting tool according to claim 1, wherein each blade forms a helix angle between about thirty degrees and about forty-five degrees with respect to the central axis.

6. The rotary cutting tool according to claim 1, further comprising a coolant hole concentric with the central axis.

7. The rotary cutting tool according to claim 1, wherein an angular spacing between the plurality of blades and the plurality of flutes is equal.

8. A rotary cutting tool with a central axis, comprising:
a shank portion;
a cutting portion extending from the shank portion to a cutting tip, the cutting portion having a plurality of blades separated by flutes, each of the blades including a leading face, a trailing face, a land surface extending between the leading face and the trailing face, and a cutting edge at an intersection between the leading face and the land surface, the cutting tip comprising a corner radius, a first portion proximate an outer diameter of the rotary cutting tool and formed with a first dish angle with respect to a plane perpendicular to the central axis, a third portion proximate the central axis and formed with a third dish angle with respect to the plane perpendicular to the central axis, and a second portion between the first and third portions and formed with a second dish angle with respect to the plane perpendicular to the central axis,
wherein the first dish angle is smaller in magnitude than the second dish angle, and wherein the second dish angle is smaller in magnitude than the third dish angle, and
wherein the trailing face contacts a work during a ramp operation in such a way that the first, second and third portions of the cutting tip have a double positive geometry, thereby enabling the rotary cutting tool to perform the ramp operation with a ramp angle of at least ten degrees.

9. The rotary cutting tool according to claim 8, wherein the rotary cutting tool comprises a solid end mill.

10. The rotary cutting tool according to claim 8, wherein each blade forms a helix angle between about thirty degrees and about forty-five degrees with respect to the central axis.

11. The rotary cutting tool according to claim 8, further comprising a coolant hole concentric with the central axis.

12. The rotary cutting tool according to claim 8, wherein an angular spacing between the plurality of blades and the plurality of flutes is equal.
